(19) United States
(12) Patent Application Publication
(10) Pub. No.: US 2026/0245938 A1
(43) Pub. Date: Aug. 20, 2026

(54) Aircraft Fuel Cells having Enhanced Interply Cohesion

(71) Applicant: Response Technologies, LLC, Coventry, RI (US)

(72) Inventor: David Allen Pettey, Portsmouth, RI (US)

(73) Assignee: Response Technologies, LLC, Coventry, RI (US)

(21) Appl. No.: 19/056,171

(22) Filed: Feb. 18, 2025

(51) Int. Cl. H01M 8/2475; B32B 3/26; B32B 5/12; B32B 5/26; B32B 7/12; B64D 27/355

(52) U.S. Cl. CPC H01M 8/2475; B32B 3/266; B32B 5/12; B32B 5/26; B32B 7/12; B64D 27/355; B32B 2262/0253; B32B 2262/0269; B32B 2307/516; B32B 2457/18; B32B 2605/18; H01M 2250/20

(57) ABSTRACT

A fuel cell for an aircraft includes a textile substrate having a plurality of perforated unidirectional textile plies that are bonded together with an elastomeric adhesive. An outer shell layer is positioned exteriorly of the textile substrate. Each of the perforated unidirectional textile plies has a hole pattern. The hole patterns of adjacent perforated unidirectional textile plies are not aligned.

### TECHNICAL FIELD OF THE DISCLOSURE

The present disclosure relates, in general, to aircraft fuel cells that have enhanced interply cohesion and, in particular, to crashworthy and ballistically tolerant fuel cells for aircraft that have perforated unidirectional textile plies that are bonded together to form a textile substrate that has a reduced risk of interply delamination.

### BACKGROUND

Fiber-based high-performance fabrics, arranged in multiple layers, have been used in various ballistic protection applications. Materials such as high-modulus and high-tenacity para-aramid fabrics like Kevlar and ultra-high molecular weight polyethylene fabrics like Dyneema, have been widely used due to their low density and excellent tensile properties. Woven and knitted fabrics made from these high-performance fibers are capable of providing protection from low level ballistic threats. Unidirectional laminates made from these high-performance fibers, however, provide enhanced ballistic performance and have gained widespread acceptance, replacing woven fabrics as the preferred solution. Commercially available variants of para-aramid unidirectional laminates and ultra-high molecular weight polyethylene unidirectional laminates typically consist of multiple layers of the unidirectional high-performance fibers arranged in a cross-ply configuration (0°/90°) with adhesive film encapsulating the unidirectional fiber layers. The adhesive film may be an elastomer adhesive film, such as a low-density polyethylene film. The layup of cross-ply unidirectional fiber layers and adhesive film layers is typically consolidated to remove any air bubbles, then cured under heat and pressure. The resultant unidirectional laminates exhibit a high strength-to-weight ratio, high impact resistance and the ability to absorb significant energy without failing. In certain applications, however, that unidirectional laminates may lack interply adhesion strength, leading to delamination of the unidirectional fiber layers within the laminate in response to stresses applied over time.

### SUMMARY

In a first aspect, the present disclosure is directed to a fuel cell for an aircraft. The fuel cell includes a textile substrate having a plurality of perforated unidirectional textile plies that are bonded together with an elastomeric adhesive. An outer shell layer is positioned exteriorly of the textile substrate. Each of the perforated unidirectional textile plies has a hole pattern. The hole patterns of adjacent perforated unidirectional textile plies are not aligned.

In some embodiments, the plurality of perforated unidirectional textile plies may include between four and twenty perforated unidirectional textile plies. In certain embodiments, the perforated unidirectional textile plies may include ultra-high molecular weight polyethylene fibers. In some embodiments, the perforated unidirectional textile plies may include para-aramid fibers. In certain embodiments, the perforated unidirectional textile plies may be perforated unidirectional laminate plies, each of which includes a plurality of layers of unidirectional material positioned in a cross-ply orientation. In some embodiments, the outer shell layer may be an elastomeric material. In certain embodiments, a fuel barrier layer may be positioned interiorly of the textile substrate. In some embodiments, the elastomeric adhesive may be positioned between adjacent perforated unidirectional textile plies and within the hole patterns of the perforated unidirectional textile plies.

In certain embodiments, the hole patterns of adjacent perforated unidirectional textile plies may be at least partially misaligned. In other embodiments, the hole patterns of adjacent perforated unidirectional textile plies may be fully misaligned. In some embodiments, the hole patterns of adjacent perforated unidirectional textile plies may have an off-axis orientation relative to each other. Alternatively or additionally, the hole patterns of adjacent perforated unidirectional textile plies may have a staggered orientation relative to each other. In certain embodiments, the hole pattern in each perforated unidirectional textile ply may create an air space of between 5 percent and 25 percent. In other embodiments, the hole pattern in each perforated unidirectional textile ply may create an air space of between 10 percent and 20 percent. In some embodiments, the hole pattern in each perforated unidirectional textile ply may include circular holes. In certain embodiments, the hole pattern in each perforated unidirectional textile ply may include noncircular holes such as oval holes. In some embodiment, the textile substrate may include one or more non-perforated unidirectional textile plies.

In a second aspect, the present disclosure is directed to an aircraft that includes an airframe and a fuel cell coupled to the airframe. The fuel cell includes a textile substrate having a plurality of perforated unidirectional textile plies that are bonded together with an elastomeric adhesive. An outer shell layer is positioned exteriorly of the textile substrate. Each of the perforated unidirectional textile plies has a hole pattern. The hole patterns of adjacent perforated unidirectional textile plies are not aligned.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIGS. 1A-1B are schematic illustrations of a tiltrotor aircraft that includes fuel cells having enhanced interply cohesion in accordance with embodiments of the present disclosure;

FIGS. 2A-2D are various views of a fuel cell having enhanced interply cohesion for a tiltrotor aircraft in accordance with embodiments of the present disclosure;

FIGS. 3A-3B are schematic illustrations of a helicopter that includes fuel cells having enhanced interply cohesion in accordance with embodiments of the present disclosure;

FIGS. 4A-4C are various views of fuel cells having enhanced interply cohesion for a helicopter in accordance with embodiments of the present disclosure;

FIGS. 5A-5D are schematic illustrations of a manufacturing process for fuel cells having enhanced interply cohesion in accordance with embodiments of the present disclosure;

FIGS. 6A-6D are schematic illustrations of manufacturing steps for fuel cells having enhanced interply cohesion in accordance with embodiments of the present disclosure;

FIG. 7A is an exploded view of a textile substrate including a plurality of perforated unidirectional textile plies for use in fuel cells having enhanced interply cohesion in accordance with embodiments of the present disclosure;

FIG. 7B is an exploded view of a unidirectional laminate ply including a plurality of unidirectional material layers in a cross ply orientation for use in fuel cells having enhanced interply cohesion in accordance with embodiments of the present disclosure;

FIG. 7C is a plan view of a perforated unidirectional textile ply for use in fuel cells having enhanced interply cohesion in accordance with embodiments of the present disclosure;

FIGS. 8A-8D are exploded views of textile substrates including a plurality of perforated unidirectional textile plies for use in fuel cells having enhanced interply cohesion in accordance with embodiments of the present disclosure;

FIG. 9 is a plan view of a perforated unidirectional textile ply for use in fuel cells having enhanced interply cohesion in accordance with embodiments of the present disclosure; and

FIG. 10 is a flowchart of a method for manufacturing fuel cells having enhanced interply cohesion in accordance with embodiments of the present disclosure.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the devices described herein may be oriented in any desired direction. As used herein, the term “coupled” may include direct or indirect coupling by any means, including by mere contact or by moving and/or non-moving mechanical connections.

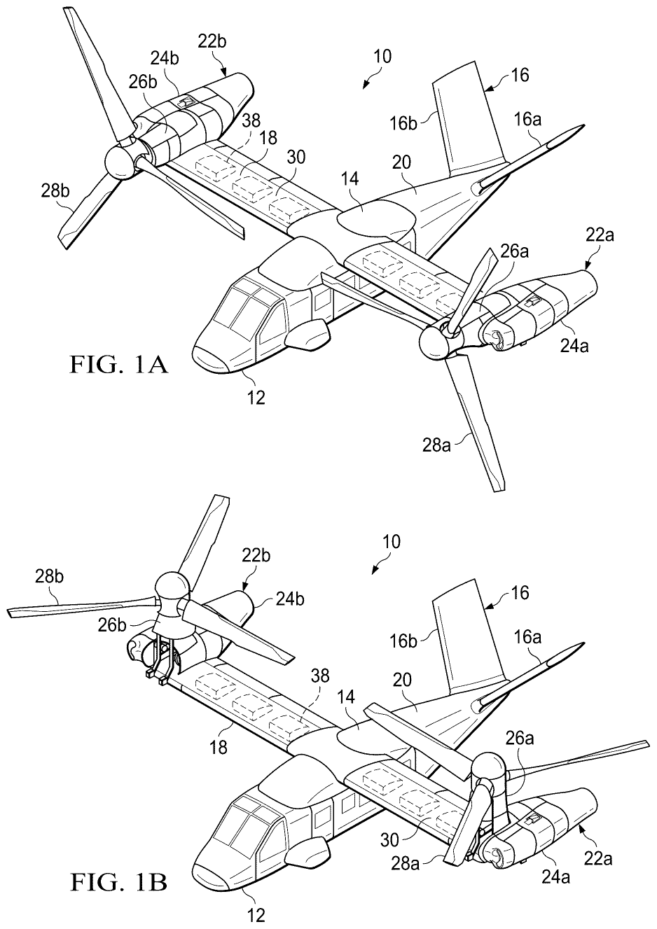

Referring initially to FIGS. 1A-1B in the drawings, a tiltrotor aircraft is schematically illustrated and generally designated 10. Aircraft 10 includes a fuselage 12, a wing mount assembly 14 and a tail section 16 including tail members 16a, 16b having control surfaces operable for horizontal and/or vertical stabilization during forward flight. A wing 18 is supported by wing mount assembly 14 and is positioned generally above fuselage 12. Together, fuselage 12, tail assembly 16 and wing 18 as well as their various frames, longerons, stringers, bulkheads, spars, ribs, skins and the like form an airframe 20 of tiltrotor aircraft 10. Located at outboard ends of wing 18 are propulsion assemblies 22a, 22b. Propulsion assembly 22a includes a fixed nacelle 24a that houses an engine and a transmission. In addition, propulsion assembly 22a includes a pylon assembly 26a that is rotatable relative to fixed nacelle 24a between a generally horizontal orientation, as best seen in FIG. 1A, and a generally vertical orientation, as best seen in FIG. 1B. Propulsion assembly 22a also includes a proprotor assembly 28a that is rotatable relative to pylon assembly 26a responsive to torque and rotational energy provided by a drive system mechanically coupled to the engine and transmission housed by fixed nacelle 24a. Similarly, propulsion assembly 22b includes a fixed nacelle 24b that houses an engine and transmission, a pylon assembly 26b that is rotatable relative to fixed nacelle 24b and a proprotor assembly 28b that is rotatable relative to pylon assembly 26b responsive to torque and rotational energy provided by a drive system mechanically coupled to the engine and transmission housed by fixed nacelle 24b.

FIG. 1A illustrates aircraft 10 in airplane or forward flight mode, in which proprotor assemblies 28a, 28b are rotating in a substantially vertical plane to provide a forward thrust enabling wing 18 to provide a lifting force responsive to forward airspeed, such that aircraft 10 flies much like a conventional propeller driven aircraft. FIG. 1B illustrates aircraft 10 in helicopter or vertical takeoff and landing (VTOL) flight mode, in which proprotor assemblies 28a, 28b are rotating in a substantially horizontal plane to provide a lifting thrust, such that aircraft 10 flies much like a conventional helicopter. It should be appreciated that aircraft 10 can be operated such that proprotor assemblies 28a, 28b are selectively positioned between forward flight mode and VTOL flight mode, which can be referred to as a conversion flight mode. Even though aircraft 10 has been described as having one engine in each fixed nacelle 24a, 24b, it should be appreciated by those having ordinary skill in the art that other engine arrangements are possible and are considered to be within the scope of the present disclosure including, for example, alternatively or additionally having one or more engines housed within fuselage 12 that provides torque and rotational energy to both proprotor assemblies 28a, 28b.

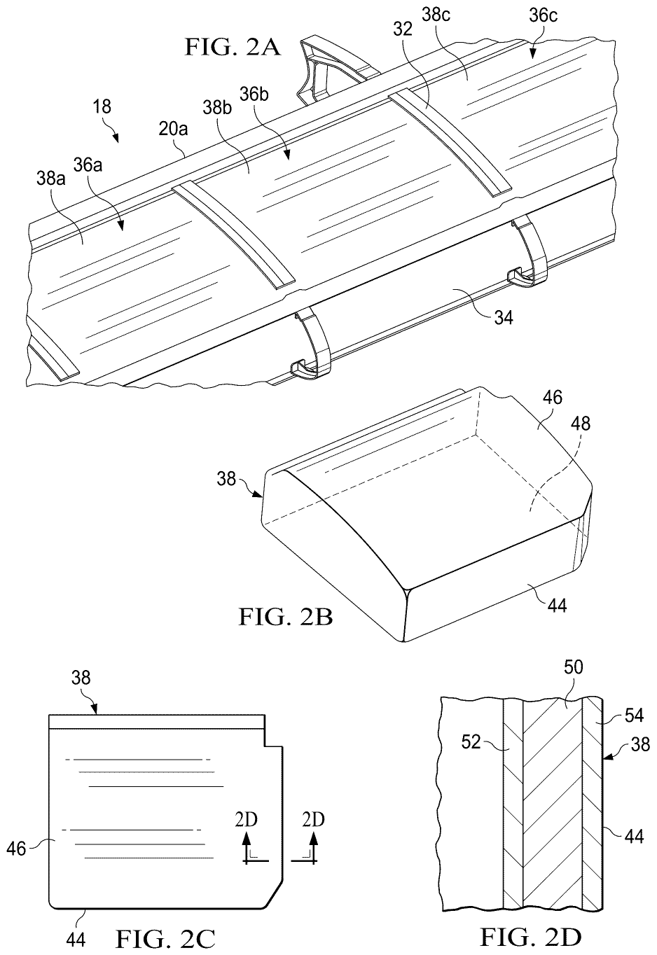

Referring additionally to FIGS. 2A-2D in the drawings, wing 18 is supported by wing airframe 20a, which includes wing skin 30 and internal support structure such as ribs 32 and spars 34. In the illustrated embodiment, wing airframe 20a forms multiple fuel cell compartments 36a, 36b, 36c that respectively receive fuel cells 38a, 38b, 38c therein. For convenience of discussion, the fuels cells of aircraft 10 may collectively and/or individually be referred to herein as fuel cells 38. Previous types of fuel cells such as rigid fuel tanks are difficult to install and service in tight fuel cell compartments such as fuel cell compartment 36a, 36b, 36c, and are highly susceptible to damage during installation, maintenance and removal processes, which may lead to premature failures such as interply delamination or other hazards. To address the need for fuel cells that are easier to install and service in tight fuel cell compartments while still meeting performance requirements, aircraft 10 includes crashworthy, ballistically tolerant and flexible fuel cells 38 that have enhanced interply cohesion. Fuel cells 38 may also be referred to as fuel bladders, fuel bags or fuel tanks.

As best seen in FIG. 2B, fuel cell 38 includes a plurality of side wall depicted as lateral walls 44, a top wall 46 and a bottom wall 48. As best seen in FIG. 2D, which is a cross section taken along line 2D-2D in FIG. 2C, fuel cell 38 includes a textile substrate 50, a fuel barrier layer 52 positioned interiorly of textile substrate 50 and an outer shell layer 54 positioned exteriorly of textile substrate 50. Fuel barrier layer 52 may be formed of any material that is chemically resistant and essentially inert to the type of fuel that fuel cell 38 is configured to contain. For example, fuel barrier layer 52 may be formed from a thermoplastic fluoropolymer such as a polyvinylidene fluoride or a polyvinylidene difluoride. Fuel barrier layer 52 may have a thickness of between 0.002 inches and 0.005 inches such as approximately 0.003 inches. In some embodiments, fuel barrier layer 52 may be imparted with electrostatic discharge properties that mitigate the chances of triggering an electrostatic discharge ignition. Fuel barrier layer 52 may also include one or more elastomeric film layers that serve as secondary fuel tolerant layers. The elastomeric film may be between 10 mils and 100 mils in thickness and may be formed from a polyurethane, a polyurea, synthetic rubbers or other elastomers. Outer shell layer 54 may be applied to the exterior surface of textile substrate 50 to add rigidity and durability to fuel cell 38. Outer shell layer 54 may be formed from an elastomeric material such a polyurea.

Textile substrate 50 is formed from multiple perforated unidirectional textile plies that are additively laid up to form textile substrate 50. In certain embodiments, textile substrate 50 may consist of between four and twenty perforated unidirectional textile plies. In other embodiments, textile substrate 50 may consist of less than four perforated unidirectional textile plies or greater than twenty perforated unidirectional textile plies. The perforated unidirectional textile plies may be formed from high performance fibers including ultra-high molecular weight polyethylene fibers such as Dyneema, para-aramid fibers such as Kevlar or combinations of high performance fibers. The perforated unidirectional textile plies may also be referred to herein as perforated unidirectional laminate plies as the perforated unidirectional textile plies typically include multiple layers of high performance fibers laminated together using liquid resins or film adhesives. The use of high performance fibers in the perforated unidirectional textile plies creates a lightweight material with high tensile strength that is resistant to ballistic impacts. As the ballistic performance and failure characteristics of various high performance fibers are different, it may be desirable to form a hybrid textile substrate that includes more than one type of high performance fiber. For example, it may be desirable to place one or more unidirectional laminate plies that have para-aramid fibers as the outboard plies together with one or more unidirectional laminate plies that have ultra-high molecular weight polyethylene fibers as the inboard plies. This arrangement has the benefit of a higher melting point material as the outer plies together with a higher energy absorption material as the inner plies.

It has been found that standard unidirectional laminate plies formed from high performance fibers may lack sufficient interply adhesion to meet certain performance standards, such as strength and endurance requirements, for miliary and/or commercial aircraft fuel bags. To overcome this shortcoming, textile substrate 50 is formed from multiple perforated unidirectional laminate plies that are additively laid up together with elastomeric adhesive such that the hole patterns in adjacent plies have a staggered or off-axis orientation which allows the elastomeric adhesive that enters the perforations, once cured, to reduce interply stress. Use of perforated unidirectional laminate plies within textile substrate 50 thus enhances interply cohesion which in turn reduces the risk of interply delamination within textile substrate 50.

Even though the fuel cells of the present disclosure have been depicted and described as been positioned within fuel cell compartments of an aircraft, it should be understood by those having ordinary skill in the art that the fuel cells of the present disclosure are equally well-suited for use as auxiliary fuel cells that may be mounted to the interior or the exterior of an aircraft. In addition, it should be appreciated that aircraft 10 is merely illustrative of a variety of aircraft that can implement the embodiments disclosed herein. Indeed, the fuel cells of the present disclosure may be implemented on any aircraft that requires fuel. Other aircraft implementations may include helicopters, hybrid aircraft, tiltwing aircraft, quad tiltrotor aircraft, unmanned aircraft, gyrocopters, fixed wing airplanes, compound helicopters, jets, drones and the like. As such, those skilled in the art will recognize that the fuel cells of the present disclosure can be integrated into a variety of aircraft configurations. It should also be appreciated that even though aircraft are particularly well-suited to implement the embodiments of the present disclosure, non-aircraft vehicles and devices such as land or water vehicles can also implement the embodiments of the present disclosure. Further, the embodiments described herein are also suitable for use in non-vehicle applications such as in tanks used for transporting fuel.

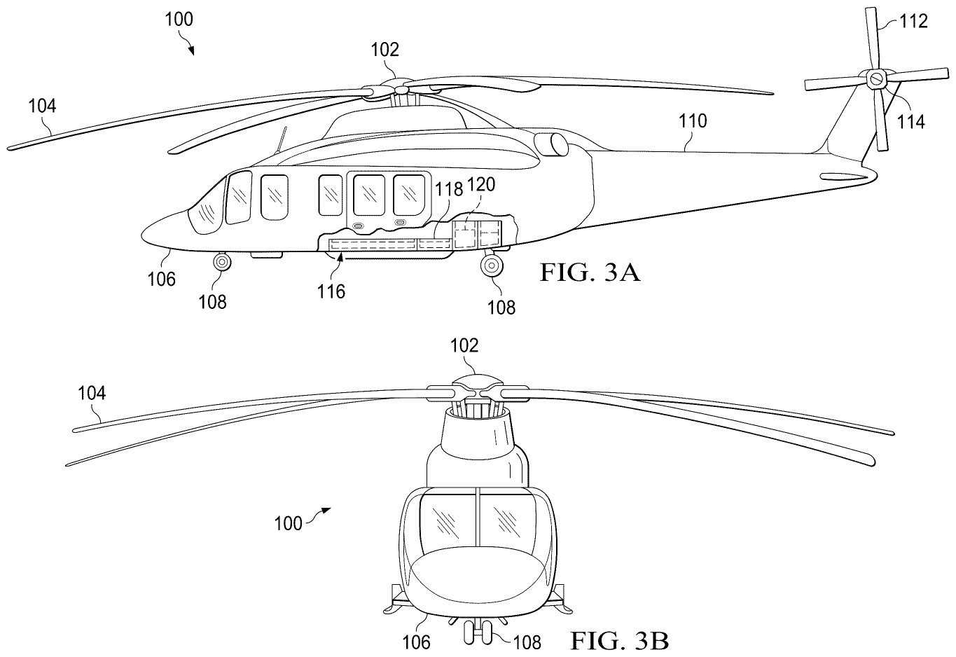

For example, referring to FIGS. 3A-3B in the drawings, a helicopter is schematically illustrated and generally designated 100. Helicopter 100 has a rotor hub assembly 102, which includes a plurality of rotor blade assemblies 104. Rotor hub assembly 102 is rotatable relative to a fuselage 106 of helicopter 100. The pitch of rotor blade assemblies 104 can be collectively and/or cyclically manipulated to selectively control direction, thrust and lift of helicopter 100. A landing gear system 108 provides ground support for helicopter 100. A tailboom 110 extends from fuselage 106. A tail rotor 112 includes a tail rotor hub assembly 114 that is rotatably coupled to the aft portion of tailboom 110. Helicopter 100 has a fuel system 116 including a fuel cell compartment 118 located in a lower portion of fuselage 106. Fuel cell compartment 118 is coupled to fuselage 106 and may be fully or partially integral with fuselage 106 or may be independent of but secured to fuselage 106. In other aircraft configurations, fuel cell compartment 118 may be located elsewhere in fuselage 106. Fuel cell compartment 118 contains a fuel tank 120. The fuel contained in fuel tank 120 is used as an energy source to power the various systems of helicopter 100 such as rotor hub assembly 102 and tail rotor hub assembly 114.

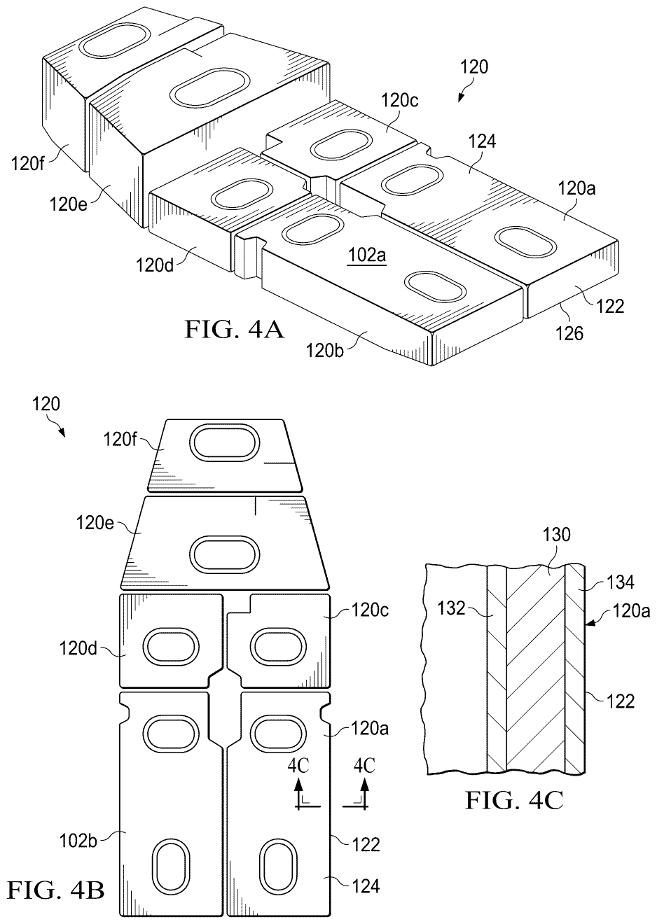

As best seen in FIGS. 4A-4C, fuel tank 120 include six interconnected fuel cells including forward fuel cells 120a, 120b, feed fuel cells 120c, 120d, mid fuel cell 120e and aft fuel cell 120f. As illustrated, the height of mid fuel cell 120e and aft fuel cell 120f is greater than that of forward fuel cells 120a, 120b and feed fuel cells 120c, 120d. The volume of fuel that may be stored in fuel tank 120 will depend on the particular implementation but will typically be on the order of several hundred to a thousand gallons. For sake of efficiency, certain features will be disclosed only with regard to fuel cell 120a. One having ordinary skill in the art, however, will fully appreciate an understanding of fuel cells 120b-120f based upon the disclosure herein of fuel cell 120a. Fuel cell 120a includes lateral walls 122, a top wall 124 and a bottom wall 126. In the illustrated embodiment, fuel cell 120a includes a textile substrate 130, a fuel barrier layer 132 positioned interiorly of textile substrate 120 and an outer shell layer 134 positioned exteriorly of textile substrate 120. Fuel barrier layer 132 is substantially similar to fuel barrier layer 52 discussed herein and may be formed from a thermoplastic fluoropolymer together with optional elastomeric film layers. Outer shell layer 134 is substantially similar to outer shell layer 54 and may formed from an elastomeric material such a polyurea. Textile substrate 130 is substantially similar to textile substrate 50 and may be formed from multiple perforated unidirectional laminate plies that are additively laid up together with elastomeric adhesive such that the hole patterns in adjacent plies have a staggered or off-axis orientation.

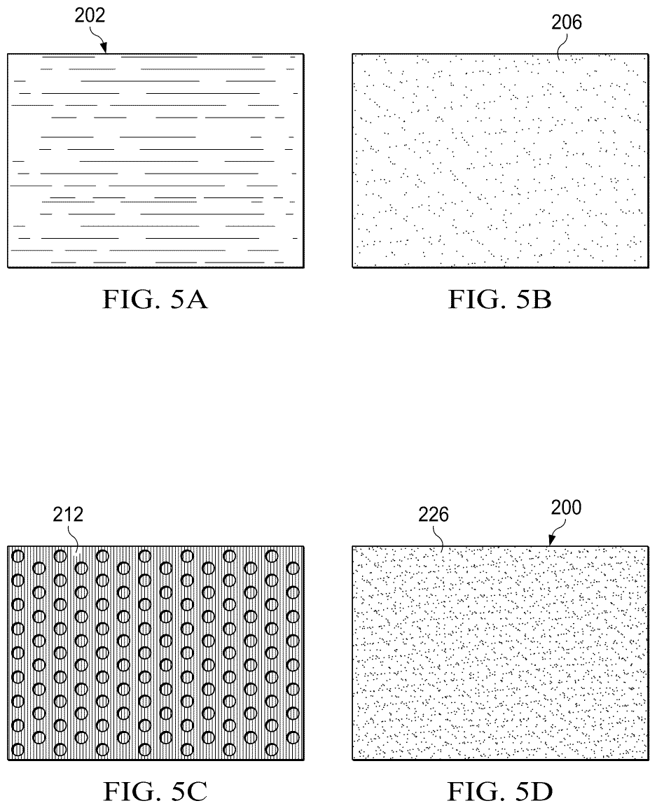

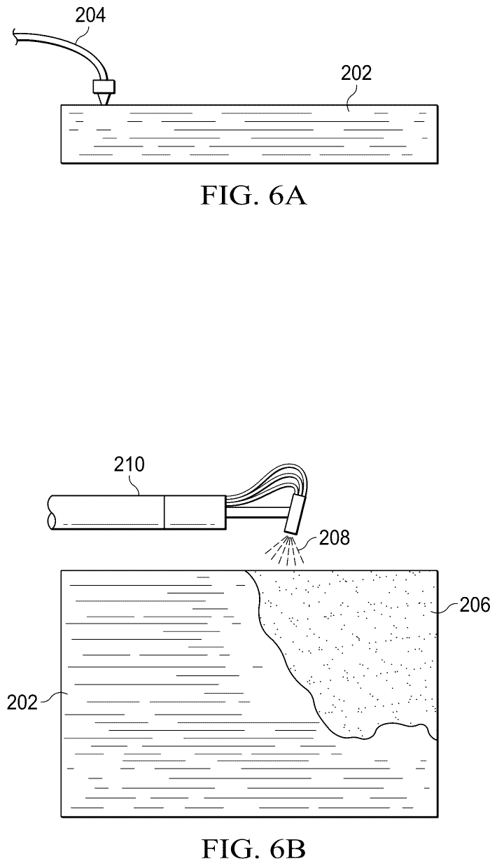

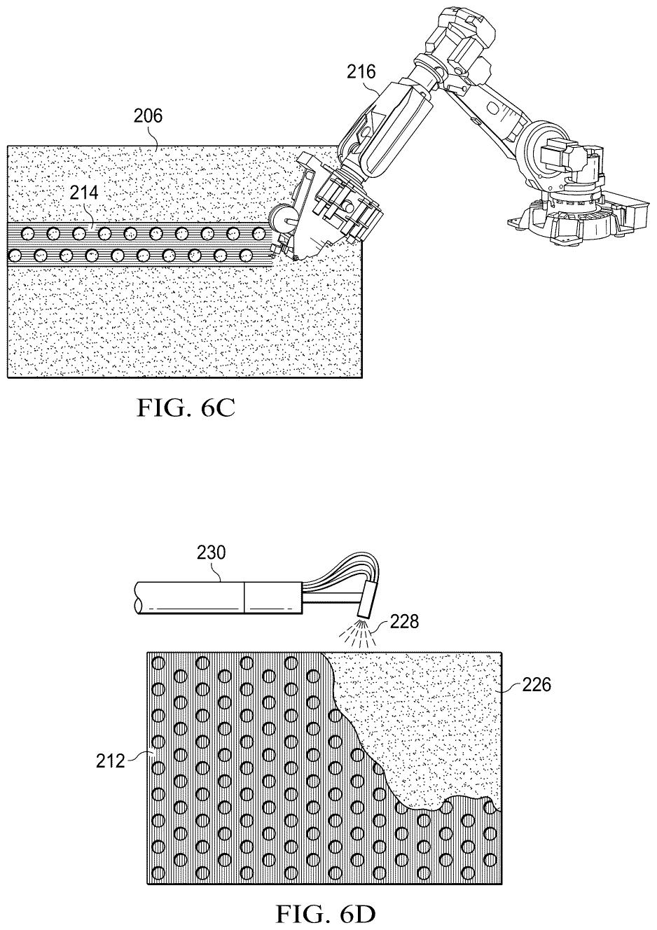

Referring to FIGS. 5A-5D in the drawings, a manufacturing process for the production of a fuel cell 200 having enhanced interply cohesion is depicted. While the manufacturing process is shown to have a particular sequence of steps, it will be appreciated that the steps shown therein may occur out of the illustrated or described order depending on the embodiment and/or application. In other embodiments, one or more illustrated or described steps may be omitted. For ease of reference, fuel cell 200 is shown to have a test cube shape, although fuel cell 200 may be manufactured in wide variety of shapes. As shown in FIG. 5A, the manufacturing process begins with a fuel cell mold 202 that acts as the surface upon which fuel cell 200 may be layered, after which fuel cell mold 202 is removed or destroyed. Thus, fuel cell mold 202 is not part of the finished fuel cell 200 that is installed in an aircraft. Fuel cell mold 202 may be manufactured using a wide variety of additive, subtractive or formative manufacturing techniques including, but not limited to, extrusion, machining, 3D printing, stamping, welding or casting as well as others. Referring additionally to FIG. 6A in the drawings, in the illustrated embodiment, fuel cell mold 202 is being 3D printed by a 3D printer 204. Fuel cell mold 202 may be 3D printed using polylactic acid, acrylonitrile butadiene styrene, Nylon or a wide variety of other 3D printable materials using a range of different 3D printing technologies such as fused deposition modeling or stereolithography. In some embodiments, a plurality of fuel cell mold segments may be 3D printed and subsequently assembled to form fuel cell mold 202. For example, fuel cell mold 202 may be 3D printed as two cupped halves joined together to form fuel cell mold 202, thereby avoiding the need for struts or other internal supports. The ability to form fuel cell mold 202 from fuel cell mold segments may also help to remove fuel cell mold 202 from fuel cell 200 after fuel cell 200 is completed.

Referring to FIG. 5B in the drawings, a fuel barrier layer 206 may be applied to the outer surface of fuel cell mold 202. Referring additionally to FIG. 6B in the drawings, fuel barrier layer 206 may be spray coated on fuel cell mold 202. In the illustrated embodiment, the fuel barrier material 208 is in the process of being robotically spray coated on fuel cell mold 202 by a spray coating machine 210, although in other embodiments fuel barrier material 208 may be manually applied on fuel cell mold 202 by brushing or other suitable technique. Fuel barrier material 208 is preferably applied in a uniform thickness over the entirety of fuel cell mold 202 to form fuel barrier layer 206. In some embodiments, a mold release agent may be applied to fuel cell mold 202 prior to applying fuel barrier layer 206.

Referring to FIG. 5C in the drawings, after fuel barrier layer 206 has been applied to fuel cell mold 202, multiple perforated unidirectional textile plies are additively laid up to form textile substrate 212. An elastomeric adhesive may be applied to fuel barrier layer 206 prior to forming textile substrate 212 thereon. In some embodiments, fuel cell mold 202 has a geometry that enables a broadcloth construction process requiring only a single layup and a single cure. The broadcloth perforated unidirectional textile plies may be placed on fuel cell mold 202 using a manual or automated layup process. A resin, such as an elastomer adhesive, is applied between each of the perforated unidirectional textile plies and is allowed to enter the perforations of each perforated unidirectional textile ply. The weight ratio of the textile material to the resin can range from 20 percent textile and 80 percent resin to 70 percent textile and 30 percent resin, although other ratios are within the scope of the illustrative embodiments. Higher textile content can provide enhanced strength and stiffness. The use of composite materials provides the ability to tailor the combination of textile and resin to meet design requirements of fuel cell 200 such as stiffness and/or flexibility. Even though a particular method of manufacture and particular materials have been described herein, it should be understood by those having ordinary skill in the art that other methods of manufacture and other materials could alternatively or additionally be used to produce textile substrate 212. For example, referring additionally to FIG. 6C in the drawings, strips of perforated unidirectional textile material, such as material strip 214, may be robotically laid up over fuel barrier layer 206. Robot 216 may be programmed to lay up the material strips in a more consistent pattern than what could otherwise be accomplished manually. In some embodiments, robot 216 may apply both the elastomer adhesive and the material strips using a co-application technique.

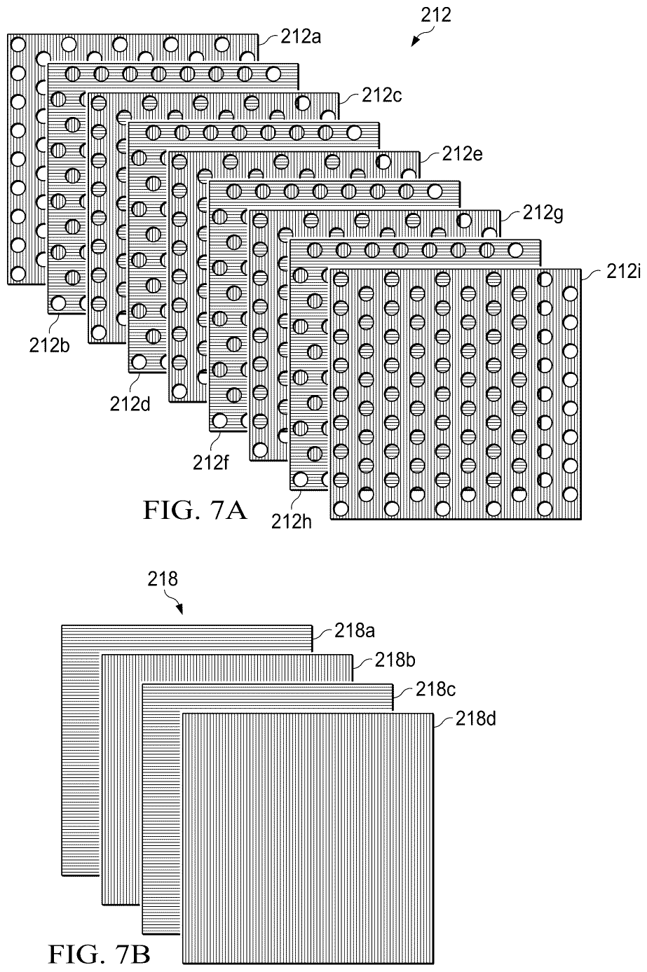

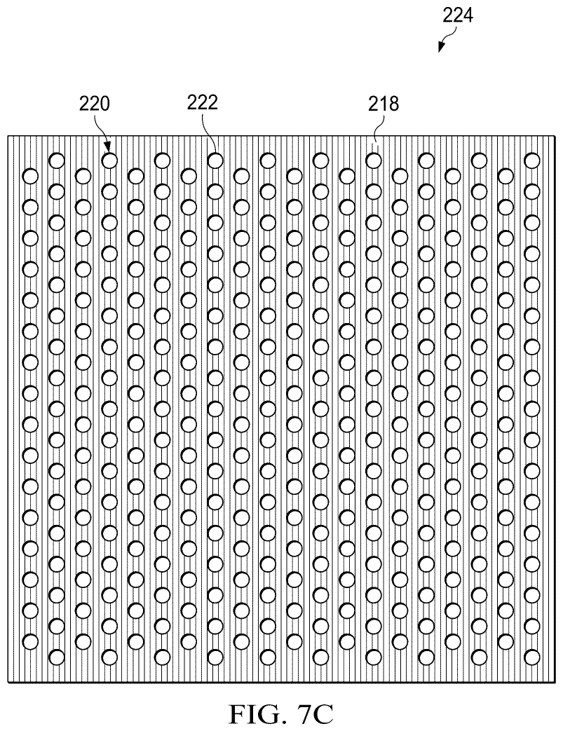

In one example, textile substrate 212 may be formed using a layup process including a plurality of perforated unidirectional textile plies. Referring additionally to FIG. 7A in the drawings, an exploded or layup view of textile substrate 212 reveals a series of perforated unidirectional textile plies 212a-212i that have a staggered orientation such that the hole patterns in adjacent plies are not aligned and more particularly, such that the hole patterns in adjacent plies are fully misaligned. Configuring adjacent perforated unidirectional textile plies in such a staggered hole pattern orientation allows textile substrate 212 to meet design requirements relating to tensile strength, shear strength, peal adhesion and material endurance, thereby reducing the risk of interply delamination within textile substrate 212. The misalignment of the hole patterns in adjacent plies allows the resin within a perforation to be sandwiched between the material of the adjacent plies on ether side thereof. This bond that extends through the perforations tends to reduce the interply stresses experience by each of the perforated unidirectional textile plies 212a-212i during use of fuel bag 200.

Each of the perforated unidirectional textile plies 212a-212i is formed from a unidirectional laminate that is perforated to form a hole pattern. Referring additionally to FIG. 7B in the drawings, an exploded or layup view of a unidirectional laminate 218 reveals a series of unidirectional fiber layers 218a-218d, in this case four layers, which have an off-axis orientation and more particularly a cross ply orientation (0°/90°). Unidirectional fiber layers 218a-218d are encapsulated together in an elastomeric resin to form unidirectional laminate 218. It is noted that while the resulting laminate could be referred to as a bidirectional laminate or a multidirectional laminate due to the multiple unidirectional fiber layers having an off-axis orientation, for the purposes of this application, the resulting laminate will be referred to as unidirectional laminate 218 due to the use of unidirectional fiber layers 218a-218d therein. Once unidirectional fiber layers 218a-218d and the encapsulating elastomeric resin have cured, the perforation process of unidirectional laminate 218 may proceed. Referring additionally to FIG. 7C in the drawings, a hole pattern 220 consisting of a plurality of holes 222 has been formed in unidirectional laminate 218 using, for example, a punch process. In the illustrated embodiment, hole pattern 220 is in the form of a uniform array of circular holes 222. In other embodiments, a hole pattern in a unidirectional laminate could have a nonuniform array of holes and/or could have holes that are noncircular. In the illustrated embodiment, hole pattern 220 in unidirectional laminate 218 creates an air space of between 5 percent and 25 percent such as an air space of between 10 percent and 20 percent or an air space of about 15 percent. In other embodiments, a hole pattern in a unidirectional laminate could create an air space of less than 5 percent or an air space of greater than 25 percent. Once hole pattern 220 has been formed in unidirectional laminate 218, this yields a perforated unidirectional textile laminate 224 that may be cut to the required sizes and shapes to form perforated unidirectional textile plies 212a-212i.

Referring again FIG. 5C in the drawings, following layup of perforated unidirectional textile plies 212a-212i and the elastomeric resin, the layup may be compacted or debulked to remove any pockets of air and to provide adequate attachment therebetween. The compacting step can be achieved by applying a vacuum to the layup in the mold, by pressurization or by pressing a second mold member or roller on the layup. Compacting not only consolidates the layup but also removes air trapped in the resin matrix that could otherwise create undesirable voids in textile substrate 212. After compacting, the layup may be cured to form textile substrate 212 using heat, pressure and/or time. For example, fuel cell mold 202 may be inserted into an autoclave and cured at elevated temperature and pressure for a predetermined time period. Following the curing process, textile substrate 212 may be trimmed or otherwise machined as desired. After curing, perforated unidirectional textile plies 212a-212i and the elastomeric resin now form a high strength, lightweight textile substrate 212 having enhanced interply cohesion.

Referring to FIG. 5D in the drawings, an outer shell layer 226 is applied on textile substrate 212. Outer shell layer 226 is formed from an elastomeric material with sufficient elasticity to enable fuel cell 200 to have desired flexibility without forming cracks or other structural discontinuities therein. Referring additionally to FIG. 6D in the drawings, outer shell layer 226 may be spray coated on textile substrate 212. In the illustrated embodiment, elastomeric material 228 is in the process of being robotically spray coated on textile substrate 212 by a spray coating machine 230, although in other embodiments elastomeric material 228 may be manually applied on textile substrate 212. Outer shell layer 226 may be applied so as to have a uniform thickness and material composition over the entirety of textile substrate 212. In some embodiments, additional layers may be applied on top of outer shell layer 226 so that outer shell layer 226 is no longer the outermost layer of fuel cell 200. In certain embodiments, one or more additional material layers may be interposed between textile substrate 212 and outer shell layer 226. Upon completion of outer shell layer 226, fuel cell mold 202 is removed from the interior of fuel cell 200. Removing fuel cell mold 202 from fuel cell 200 may involve dismantled fuel cell mold 202 for future or repeat use or destructively removed fuel cell mold 202 for a one-time use. After removing fuel cell mold 202, fuel barrier layer 206, textile substrate 212 and outer shell layer 226 now form a crashworthy, ballistically tolerant fuel cell 200 having enhanced interply cohesion.

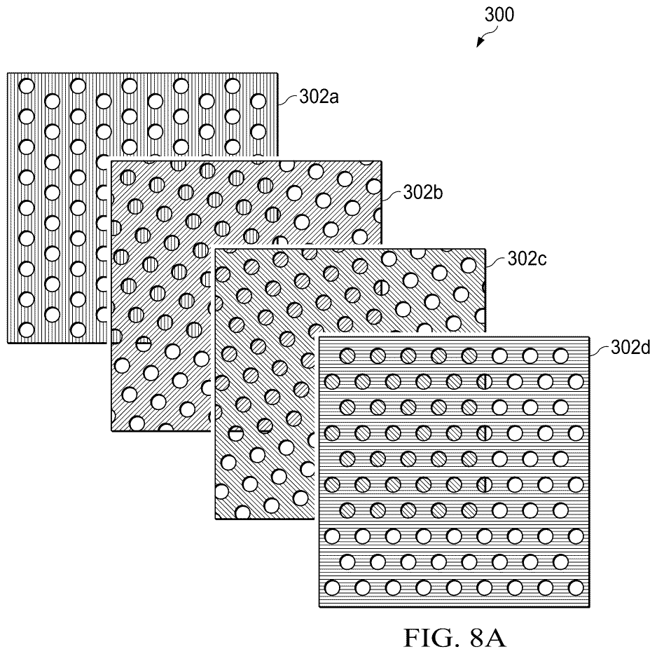

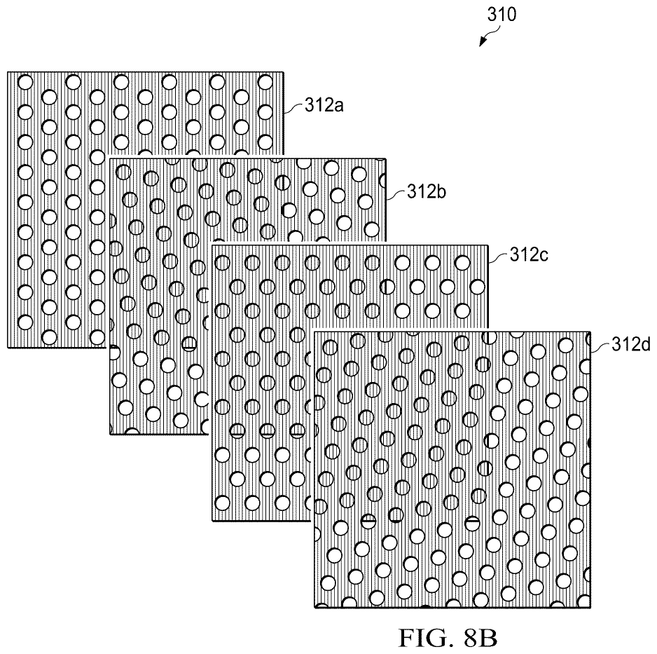

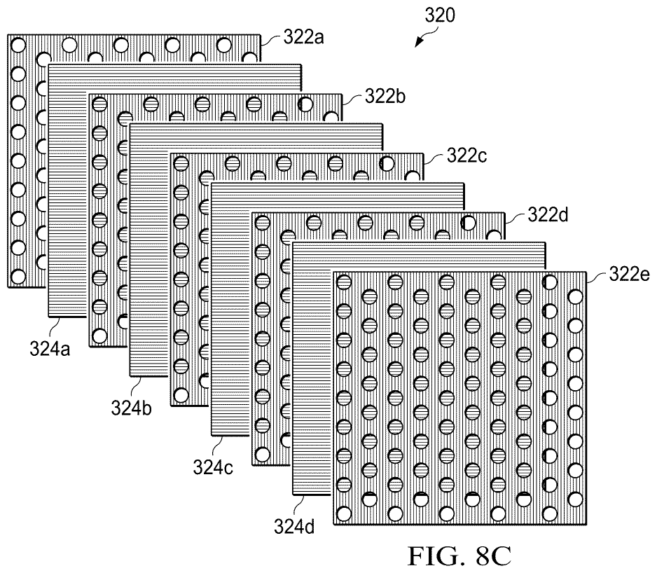

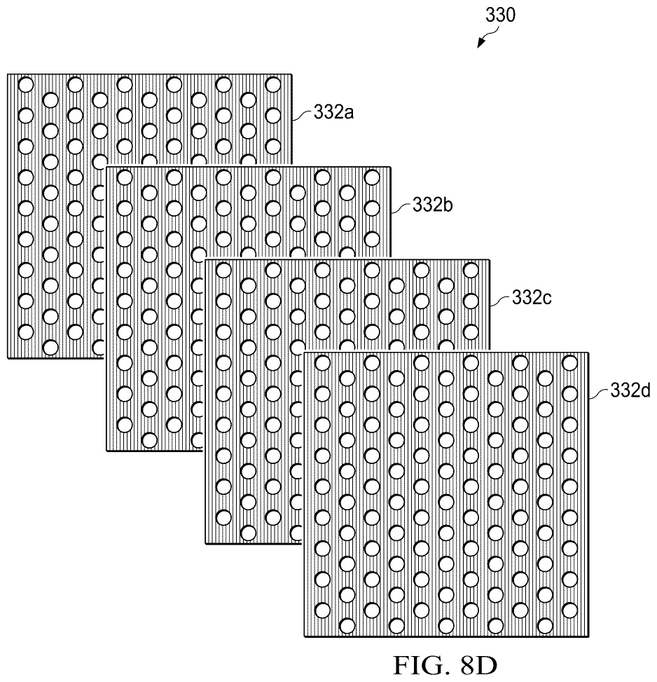

Even though textile substrate 212 has been described and depicted as having perforated unidirectional textile plies 212a-212i in a staggered orientation such that the hole patterns in adjacent plies are not aligned, it should be understood by those having ordinary skill in the art that a textile substrate could have perforated unidirectional textile plies in other orientations such that the hole patterns in adjacent plies are not aligned. For example, referring to FIG. 8A in the drawings, an exploded or layup view of a textile substrate 300 is depicted. Textile substrate 300 includes a series of perforated unidirectional textile plies 302a, 302b, 302c, 302d that have an off-axis orientation and more particularly a 0°/45°/−45°/90° orientation. In the illustrated embodiment, otherwise identical perforated unidirectional textile plies are rotated relative to each other in the layup process such that the hole patterns in adjacent plies are not aligned. In this case, using off-axis orientation results in the hole patterns in adjacent plies being at least partially misaligned as there tends to be at least some overlap between some of the holes in adjacent plies. Configuring adjacent perforated unidirectional textile plies with such off-axis hole pattern orientation allows textile substrate 300 to meet design requirements relating to tensile strength, shear strength, peal adhesion and material endurance, thereby reducing the risk of interply delamination within textile substrate 300. The misalignment of the hole patterns in adjacent plies allows the resin within a perforation to be sandwiched between the material of the adjacent plies on either side thereof which tends to reduce the interply stresses experience by each of perforated unidirectional textile plies 302a, 302b, 302c, 302d in textile substrate 300. Even though textile substrate 300 has been described and depicted as having perforated unidirectional textile plies 302a, 302b, 302c, 302d in a particular off-axis orientation, it should be understood by those having ordinary skill in the art that a textile substrate could have perforated unidirectional textile plies in other off-axis orientations including, but not limited to 0°/90°/45°/−45°, 0°/45°/90°/−45°, 60°/15°/−75°/−30° or other suitable off-axis orientation.

Referring to FIG. 8B in the drawings, an exploded or layup view of a textile substrate 310 is depicted. Textile substrate 310 includes a series of perforated unidirectional textile plies 312a, 312b, 312c, 312d that have hole patterns in an off-axis orientation and more particularly a 0°/45°/90°/−45° orientation. In the illustrated embodiment, the unidirectional laminates are rotated prior to perforation such that the hole patterns are clocked relative to the fibers of the unidirectional laminates. In this case, a layup of perforated unidirectional textile plies with parallel fiber directionality results in the off-axis orientation of the hole patterns such that the hole patterns in adjacent plies are at least partially misaligned as there tends to be at least some overlap between some of the holes in adjacent plies. Configuring adjacent perforated unidirectional textile plies with such off-axis hole pattern orientation allows textile substrate 310 to meet design requirements relating to tensile strength, shear strength, peal adhesion and material endurance, thereby reducing the risk of interply delamination within textile substrate 310. The misalignment of the hole patterns in adjacent plies allows the resin within a perforation to be sandwiched between the material of the adjacent plies on either side thereof which tends to reduce the interply stresses experience by each of perforated unidirectional textile plies 312a, 312b, 312c, 312d in textile substrate 310.

Even though each of the plies in the textile substrates described and depicted herein have been perforated unidirectional textile plies, it should be understood by those having ordinary skill in the art that a textile substrate could have a combination of perforated unidirectional textile plies and non-perforated unidirectional textile plies. For example, referring to FIG. 8C in the drawings, an exploded or layup view of a textile substrate 320 is depicted. Textile substrate 320 includes a series of perforated unidirectional textile plies 322a, 322b, 322c, 322d, 322e with a series of non-perforated unidirectional textile plies 324a, 324b, 324c, 324d interspersed therebetween. In the illustrated embodiment, adjacent perforated unidirectional textile plies such as plies 322a, 322b have hole patterns that are aligned. In other embodiments, the hole patterns in adjacent perforated unidirectional textile plies that have non-perforated unidirectional textile plies interspersed therebetween could be staggered or could have an off-axis orientation. In either case, having perforated unidirectional textile plies 322a, 322b, 322c, 322d, 322e with non-perforated unidirectional textile plies 324a, 324b, 324c, 324d interspersed therebetween allows textile substrate 320 to meet design requirements relating to tensile strength, shear strength, peal adhesion and material endurance, thereby reducing the risk of interply delamination within textile substrate 320.

In addition, it should be understood by those having ordinary skill in the art that a textile substrate without non-perforated unidirectional textile plies could be laid up with the hole patterns in adjacent perforated unidirectional textile plies aligned. For example, referring to FIG. 8D in the drawings, an exploded or layup view of a textile substrate 330 is depicted. Textile substrate 330 includes a series of perforated unidirectional textile plies 332a, 332b, 332c, 332d that have hole patterns that are aligned. This arrangement allows textile substrate 330 to meet design requirements relating to tensile strength, shear strength, peal adhesion and material endurance, thereby reducing the risk of interply delamination within textile substrate 330.

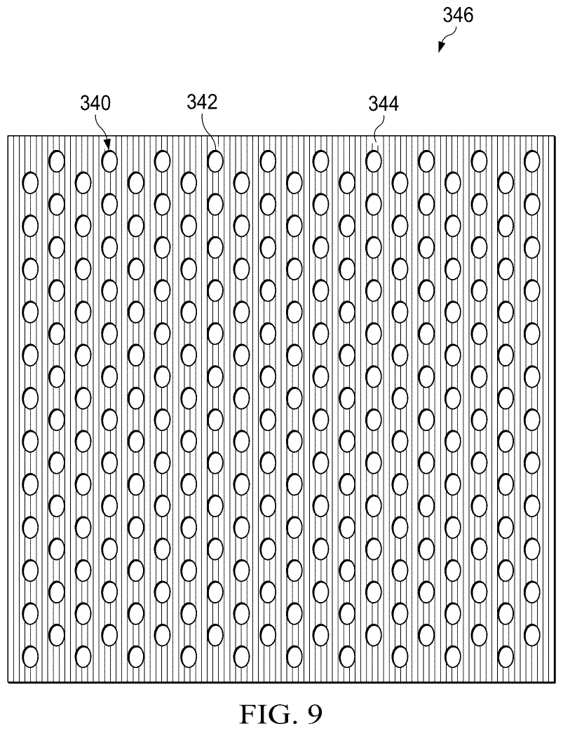

Even though the perforated unidirectional textile plies described and depicted herein include hole patterns that have circular holes, it should be understood by those having ordinary skill in the art that perforated unidirectional textile plies of the present disclosure could have hole patterns that have noncircular holes such as square holes, rectangular holes, diamond shaped holes or other suitably shaped holes. For example, referring to FIG. 9 in the drawings, a hole pattern 340 consisting of a plurality of holes 342 has been formed in a unidirectional laminate 344 using, for example, a punch process. In the illustrated embodiment, hole pattern 340 is in the form of a uniform array of noncircular, and in this case, oval holes 342. Similar to hole pattern 220 in unidirectional laminate 218 discussed herein, hole pattern 340 in unidirectional laminate 344 creates an air space of between 5 percent and 25 percent such as an air space of between 10 percent and 20 percent or an air space of about 15 percent. Once hole pattern 340 has been formed in unidirectional laminate 344, this yields a perforated unidirectional textile laminate 346 that may be cut to the required sizes and shapes to form perforated unidirectional textile plies. Perforated unidirectional textile plies that have hole pattern 340 may be laid up in a staggered orientation or an off-axis orientation such that the hole patterns in adjacent plies are not aligned or may be laid up such that the hole patterns in adjacent plies are aligned.

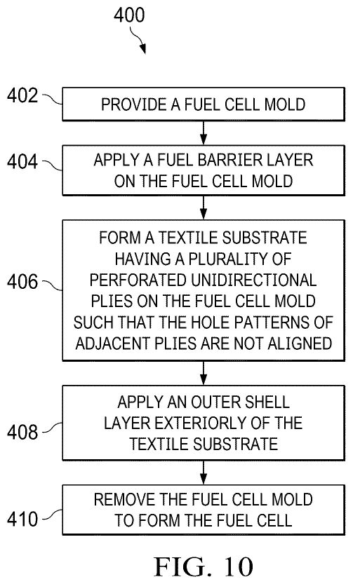

Referring to FIG. 10 in the drawings, a method for manufacturing fuel cells have enhanced interply cohesion for aircraft is depicted. Method 400 includes providing a fuel cell mold (step 402). Next, method 400 includes applying a fuel barrier layer on the fuel cell mold (step 404). Method 400 also includes forming a textile substrate having a plurality of perforated unidirectional textile plies on the fuel cell mold such that the hole patterns of adjacent plies are not aligned (step 406). Next, method 400 includes applying an outer shell layer exteriorly of the textile substrate (step 408) and removing the fuel cell mold to form the fuel cell (step 410).

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. For example, numerous combinations of the features disclosed herein will be apparent to persons skilled in the art including the combining of features described in different and diverse embodiments, implementations, contexts, applications and/or figures. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

What is claimed is:

1. A fuel cell for an aircraft, the fuel cell comprising:
a textile substrate having a plurality of perforated unidirectional textile plies that are bonded together with an elastomeric adhesive; and
an outer shell layer positioned exteriorly of the textile substrate;
wherein, each of the perforated unidirectional textile plies has a hole pattern; and
wherein, the hole patterns of adjacent perforated unidirectional textile plies are not aligned.

2. The fuel cell as recited in claim 1 wherein, the plurality of perforated unidirectional textile plies includes between four and twenty perforated unidirectional textile plies.

3. The fuel cell as recited in claim 1 wherein, the perforated unidirectional textile plies further comprise ultra-high molecular weight polyethylene fibers.

4. The fuel cell as recited in claim 1 wherein, the perforated unidirectional textile plies further comprise para-aramid fibers.

5. The fuel cell as recited in claim 1 wherein, the perforated unidirectional textile plies further comprise perforated unidirectional laminate plies.

6. The fuel cell as recited in claim 5 wherein, each of the perforated unidirectional laminate plies further comprises a plurality of layers of unidirectional material positioned in a cross-ply orientation.

7. The fuel cell as recited in claim 1 wherein, the outer shell layer further comprises an elastomeric material.

8. The fuel cell as recited in claim 1 further comprising a fuel barrier layer positioned interiorly of the textile substrate.

9. The fuel cell as recited in claim 1 wherein, the elastomeric adhesive is positioned between adjacent perforated unidirectional textile plies and within the hole patterns of the perforated unidirectional textile plies.

10. The fuel cell as recited in claim 1 wherein, the hole patterns of adjacent perforated unidirectional textile plies are at least partially misaligned.

11. The fuel cell as recited in claim 1 wherein, the hole patterns of adjacent perforated unidirectional textile plies are fully misaligned.

12. The fuel cell as recited in claim 1 wherein, the hole patterns of adjacent perforated unidirectional textile plies have an off-axis orientation relative to each other.

13. The fuel cell as recited in claim 1 wherein, the hole patterns of adjacent perforated unidirectional textile plies have a staggered orientation relative to each other.

14. The fuel cell as recited in claim 1 wherein, the hole pattern in each perforated unidirectional textile ply creates an air space of between 5 percent and 25 percent.

15. The fuel cell as recited in claim 1 wherein, the hole pattern in each perforated unidirectional textile ply creates an air space of between 10 percent and 20 percent.

16. The fuel cell as recited in claim 1 wherein, the hole pattern in each perforated unidirectional textile ply includes circular holes.

17. The fuel cell as recited in claim 1 wherein, the hole pattern in each perforated unidirectional textile ply includes oval holes.

18. The fuel cell as recited in claim 1 wherein, the hole pattern in each perforated unidirectional textile ply includes noncircular holes.

19. The fuel cell as recited in claim 1 wherein, the textile substrate includes one or more non-perforated unidirectional textile plies.

20. An aircraft comprising:
an airframe; and
a fuel cell coupled to the airframe, the fuel cell comprising:
a textile substrate having a plurality of perforated unidirectional textile plies that are bonded together with an elastomeric adhesive; and
an outer shell layer positioned exteriorly of the textile substrate;
wherein, each of the perforated unidirectional textile plies has a hole pattern; and
wherein, the hole patterns of adjacent perforated unidirectional textile plies are not aligned.
